(19) United States
(12) Patent Application Publication
(10) Pub. No.: US 2025/0130318 A1
(43) Pub. Date: Apr. 24, 2025

(54) LIDAR SYSTEM HAVING OPTICAL BACK SCATTER RECOVERY

(71) Applicant: Allegro MicroSystems, LLC, Manchester, NH (US)

(72) Inventors: Stephen A. Marshall, Portland, OR (US); Adam Lee, Portland, OR (US); Charles Myers, Portland, OR (US)

(73) Assignee: Allegro MicroSystems, LLC, Manchester, NH (US)

(21) Appl. No.: 18/490,041

(22) Filed: Oct. 19, 2023

(51) Int. Cl. G01S 7/4861; G01S 7/481; G01S 17/42; G01S 17/894

(52) U.S. Cl. CPC G01S 7/4861; G01S 7/4816; G01S 17/42; G01S 17/894

(57) ABSTRACT

Methods and apparatus for optical detection having fast recovery from high amplitude input signals. In embodiments, a LIDAR system includes a photoreceiver to receive a return signal, and a circuit to modulate a gain of the photoreceiver over an acquisition window for the return signal, wherein the acquisition window contains time T0, and wherein the gain at time T0 is at a minimum for the acquisition window. In embodiments, the time T0 is at the beginning of the acquisition window.

### BACKGROUND

As is known in the art, pixel circuits used in photonic detection systems look for active transient signals indicating optical returns from pulse-illuminated scenes of interest. The pulsed illumination propagates from the optical source, reflects off objects in the active imaging system field of view, and returns towards the active imaging system. Pixels in the active imaging convert this input energy, generally photo-current from a photo-detector device, into a voltage signal that is compared to a threshold for detecting the presence and timing of an active optical return. The timing information from this active system is used to calculate range to an object in the field of view of the active imaging system.

### SUMMARY

Example embodiments of the disclosure provide methods and apparatus for optical detection systems having a photoreceiver configured to recover from high-amplitude pulses during an initial period of the acquisition time window that may be caused, for example, by optical back-scatter from the outgoing optical pulse or other very close-range reflections. In embodiments, a system may recover from a high-amplitude pulse within 10 ns or within two meters of visible distance. As used herein, the term “recover” means that the optical detection system is ready to process a new pulse.

In some embodiments, a system modulates the gain of a photoreceiver over the duration of a signal acquisition window, such that the system has a low gain at the beginning of the acquisition window and a progressively higher gain over remaining acquisition window. Gain adjustment during the acquisition window may have a profile over time configured to meet the needs of a particular application. In some embodiments, an offset of the system can be corrected for high-gain configurations. In some embodiments, a system can adjust a dynamic range and/or damage threshold of a photoreceiver over the duration of the acquisition window.

In one aspect, a method comprises: configuring a photoreceiver of a LIDAR system to receive a return signal; and modulating a gain of the photoreceiver over an acquisition window for the return signal, wherein the acquisition window contains time T0, and wherein the gain at time T0 is at a minimum for the acquisition window.

A method can further include ore or more of the following features: the time T0 is at the beginning of the acquisition window, modulating the gain of the photoreceiver includes selecting the gain to keep a backscatter pulse for the return signal below a detection threshold, a profile of the gain is linear, the photoreceiver includes a photodiode coupled to an amplifier having a feedback circuit which includes a variable impedance module that controls the gain, adjusting a control signal to the variable impedance module for controlling an impedance of the variable impedance module and adjusting the gain, the variable impedance module comprises a first MOS device, operating the first MOS device in a linear region, using an RC network to generate the control signal to the variable impedance module, generating the control signal to the variable impedance module to reduce switching charge injection, using a digital arbitrary waveform generator to generate the control signal to the variable impedance module, a lookup table to control the digital arbitrary waveform generator, the photoreceiver includes a differential circuit to process the return signal, the photoreceiver includes an amplifier and a voltage discriminator and a threshold generator to generate a threshold for the voltage discriminator, and controlling the threshold for the voltage discriminator to be greater than a minimum at the beginning of the acquisition window, a profile of the gain is nonlinear, a profile of the gain is proportional to a square of elapsed time for distance from a target that generates the signal return, and/or a first timing signal trn and a second timing signal chn are staggered in time and coupled to further MOS devices swp1, swn1, and swp2 to actuate a gate voltage V_{rmod} to reset the V_{rmod} voltage between signal acquisitions and to enable V_{rmod} modulation to be triggered with a charge injection over a threshold level through parasitic capacitances.

In another aspect, a LIDAR system comprises: a photoreceiver to receive a return signal; and a circuit to modulate a gain of the photoreceiver over an acquisition window for the return signal, wherein the acquisition window contains time T0, and wherein the gain at time T0 is at a minimum for the acquisition window.

A system can further include ore or more of the following features: the time T0 is at the beginning of the acquisition window, modulating the gain of the photoreceiver includes selecting the gain to keep a backscatter pulse for the return signal below a detection threshold, a profile of the gain is linear, the photoreceiver includes a photodiode coupled to an amplifier having a feedback circuit which includes a variable impedance module that controls the gain, adjusting a control signal to the variable impedance module for controlling an impedance of the variable impedance module and adjusting the gain, the variable impedance module comprises a first MOS device, operating the first MOS device in a linear region, using an RC network to generate the control signal to the variable impedance module, generating the control signal to the variable impedance module to reduce switching charge injection, using a digital arbitrary waveform generator to generate the control signal to the variable impedance module, a lookup table to control the digital arbitrary waveform generator, the photoreceiver includes a differential circuit to process the return signal, the photoreceiver includes an amplifier and a voltage discriminator and a threshold generator to generate a threshold for the voltage discriminator, and controlling the threshold for the voltage discriminator to be greater than a minimum at the beginning of the acquisition window, a profile of the gain is nonlinear, a profile of the gain is proportional to a square of elapsed time for distance from a target that generates the signal return, and/or a first timing signal trn and a second timing signal chn are staggered in time and coupled to further MOS devices swp1, swn1, and swp2 to actuate a gate voltage V_{rmod} to reset the V_{rmod} voltage between signal acquisitions and to enable V_{rmod} modulation to be triggered with a charge injection over a threshold level through parasitic capacitances.

### BRIEF DESCRIPTION OF THE DRAWINGS

The foregoing features of this disclosure, as well as the disclosure itself, may be more fully understood from the following description of the drawings in which:

FIG. 1 is a block diagram of an example LIDAR system having a gain profile for fast recovery from high amplitude pulses;

FIG. 2 is a circuit diagram of an example LIDAR system having a variable impedance module to control the gain profile;

FIG. 3A is a graphical representation of an example gain profile for the system of FIG. 2; FIG. 3B is a graphical representation of example pulses received by the system; FIG. 3C is a graphical representation of a gain profile of a prior art LIDAR photoreceiver; and FIG. 3D is a graphical representation of an example response to the pulses of FIG. 3B by the system of FIG. 2 for the gain profile of FIG. 3A;

FIG. 4 is a circuit diagram of an example implementation of a photoreceiver having a gain profile to promote fast recovery from large pulses at the beginning of an acquisition window;

FIG. 5A is a circuit diagram of an example analog circuit to generate a control signal and FIG. 5B is a circuit diagram of an example analog circuit to generate a control signal;

FIG. 6 is a circuit diagram of an example differential photoreceiver;

FIG. 7 is a graphical representation of a photoreceiver response for undesirable large first pulse and a desired smaller second pulse;

FIG. 8A is an example circuit diagram of an example variable impedance circuit implementation forming a part of the photoreceiver of FIG. 8B; FIG. 8C is a graphical representation of an example gain profile generated by the circuit of FIG. 8A; and FIG. 8D is a timing diagram for signals in the circuit of FIG. 8A;

FIG. 9 is a graphical representation of an example arbitrary gain profile;

FIG. 10A is a schematic representation of an example control signal generator and FIG. 10B is a graphical representation of an arbitrary gain profile;

FIG. 11 is a flow diagram showing an example sequence of steps for adjusting a gain profile in a LIDAR photoreceiver; and

FIG. 12 is a schematic representation of an example computer that can perform at least a portion of the processing described herein.

### DETAILED DESCRIPTION

Prior to describing example embodiments of the disclosure some information is provided. Laser ranging systems can include laser radar (ladar), light-detection and ranging (lidar), and rangefinding systems, which are generic terms for the same class of instrument that uses light to measure the distance to objects in a scene. This concept is similar to radar, except optical signals are used instead of radio waves. Similar to radar, a laser ranging and imaging system emits an optical signal, e.g., a pulse or continuous optical signal, toward a particular location and measures return reflections to extract range information.

Laser ranging systems generally work by emitting a laser pulse and recording the time it takes for the laser pulse to travel to a target, reflect, and return to a photoreceiver. The laser ranging instrument records the time of the outgoing pulse—either from a trigger or from calculations that use measurements of the scatter from the outgoing laser light—and then records the time that a laser pulse returns. The difference between these two times is the time of flight to and from the target. Using the speed of light, the round-trip time of the pulses is used to calculate the distance to the target.

Lidar systems may scan the beam across a target area to measure the distance to multiple points across the field of view, producing a full three-dimensional range profile of the surroundings. More advanced flash lidar cameras, for example, contain an array of detector elements, each able to record the time of flight to objects in their field of view.

When using light pulses to create images, the emitted pulse may intercept multiple objects, at different orientations, as the pulse traverses a 3D volume of space. The reflected laser-pulse waveform contains a temporal and amplitude imprint of the scene. By sampling the light reflections, a record of the interactions of the emitted pulse is extracted with the intercepted objects of the scene, allowing an accurate multi-dimensional image to be created. To simplify signal processing and reduce data storage, laser ranging and imaging can be dedicated to discrete-return systems, which record only the time of flight (TOF) of the first, or a few, individual target returns to obtain angle-angle-range images. In a discrete-return system, each recorded return corresponds, in principle, to an individual laser reflection (i.e., a reflection from one particular reflecting surface, for example, a vehicle, a person, a tree, pole or building). By recording just a few individual ranges, discrete-return systems simplify signal processing and reduce data storage, but they do so at the expense of lost target and scene reflectivity data. Because laser-pulse energy has significant associated costs and drives system size and weight, recording the TOF and pulse amplitude of more than one laser pulse return per transmitted pulse, to obtain angle-angle-range-intensity images, increases the amount of captured information per unit of pulse energy. All other things equal, capturing the full pulse return waveform offers significant advantages, such that the maximum data is extracted from the investment in average laser power. In full-waveform systems, each laser pulse received by the system is digitized at a high sampling rate (e.g., 500 MHz to 1.5 GHz). This process generates digitized waveforms (amplitude versus time) that may be processed to achieve higher-fidelity 3D images.

Of the various laser ranging instruments available, those with single-element photoreceivers generally obtain range data along a single range vector, at a fixed pointing angle. This type of instrument—which is, for example, commonly used by golfers and hunters—either obtains the range (R) to one or more targets along a single pointing angle or obtains the range and reflected pulse intensity (I) of one or more objects along a single pointing angle, resulting in the collection of pulse range-intensity data, (R,I)ᵢ, where i indicates the number of pulse returns captured for each outgoing laser pulse.

More generally, laser ranging instruments can collect ranging data over a portion of the solid angles of a sphere, defined by two angular coordinates (e.g., azimuth and elevation), which can be calibrated to three-dimensional (3D) rectilinear cartesian coordinate grids; these systems are generally referred to as 3D lidar and ladar instruments. The terms “lidar” and “ladar” are often used synonymously and, for the purposes of this discussion, the terms “3D lidar,” “scanned lidar,” or “lidar” are used to refer to these systems without loss of generality. 3D lidar instruments obtain three-dimensional (e.g., angle, angle, range) data sets. Conceptually, this would be equivalent to using a rangefinder and scanning it across a scene, capturing the range of objects in the scene to create a multi-dimensional image. When only the range is captured from the return laser pulses, these instruments obtain a 3D data set (e.g., angle, angle, range)ₙ, where the index n is used to reflect that a series of range-resolved laser pulse returns can be collected, not just the first reflection.

Some 3D lidar instruments are also capable of collecting the intensity of the reflected pulse returns generated by the objects located at the resolved (angle, angle, range) objects in the scene. When both the range and intensity are recorded, a multi-dimensional data set [e.g., angle, angle, (range-intensity)ₙ] is obtained. This is analogous to a video camera in which, for each instantaneous field of view (FOV), each effective camera pixel captures both the color and intensity of the scene observed through the lens. However, 3D lidar systems, instead capture the range to the object and the reflected pulse intensity.

Lidar systems can include different types of lasers, including those operating at different wavelengths, including those that are not visible (e.g., those operating at a wavelength of 840 nm or 905 nm), and in the near-infrared (e.g., those operating at a wavelength of 1064 nm or 1550 nm), and the thermal infrared including those operating at wavelengths known as the “eyesafe” spectral region (i.e., generally those operating at a wavelength beyond about 1400-nm), where ocular damage is less likely to occur. Lidar transmitters are generally invisible to the human eye.

However, when the wavelength of the laser is close to the range of sensitivity of the human eye—roughly 350 nm to 730 nm—the energy of the laser pulse and/or the average power of the laser must be lowered such that the laser operates at a wavelength to which the human eye is not sensitive. Thus, a laser operating at, for example, 1550 nm, can without causing ocular damage—generally have 200 times to 1 million times more laser pulse energy than a laser operating at 840 nm or 905 nm.

One challenge for a lidar system is detecting poorly reflective objects at long distance, which requires transmitting a laser pulse with enough energy that the return signal reflected from the distant target—is of sufficient magnitude to be detected. To determine the minimum required laser transmission power, several factors must be considered. For instance, the magnitude of the pulse returns scattering from the diffuse objects in a scene is proportional to their range and the intensity of the return pulses generally scales with distance according to 1/R\hat{ }4 for small objects and 1/R\hat{ }2 for larger objects; yet, for highly-specularly reflecting objects (i.e., those objects that are not diffusively-scattering objects), the collimated laser beams can be directly reflected back, largely unattenuated. This means that—if the laser pulse is transmitted, then reflected from a target 1 meter away—it is possible that the full energy (J) from the laser pulse will be reflected into the photoreceiver; but—if the laser pulse is transmitted, then reflected from a target 333 meters away—it is possible that the return will have a pulse with energy approximately 10\hat{ }12 weaker than the transmitted energy.

In many cases of lidar systems highly-sensitive photoreceivers are used to increase the system sensitivity to reduce the amount of laser pulse energy that is needed to reach poorly reflective targets at the longest distances required, and to maintain eyesafe operation. Some variants of these detectors include those that incorporate photodiodes, and/or offer gain, such as avalanche photodiodes (APDs) or single-photon avalanche detectors (SPADs). These variants can be configured as single-element detectors,-segmented-detectors, linear detector arrays, or area detector arrays. Using highly sensitive detectors such as APDs or SPADs reduces the amount of laser pulse energy required for long-distance ranging to poorly reflective targets. The technological challenge of these photodetectors is that they must also be able to accommodate the incredibly large dynamic range of signal amplitudes.

As dictated by the properties of the optics, the focus of a laser return changes as a function of range; as a result, near objects are often out of focus. Furthermore, also as dictated by the properties of the optics, the location and size of the “blur”—i.e., the spatial extent of the optical signal-changes as a function of range, much like in a standard camera. These challenges are commonly addressed by using large detectors, segmented detectors, or multi-element detectors to capture all of the light or just a portion of the light over the full-distance range of objects. It is generally advisable to design the optics such that reflections from close objects are blurred, so that a portion of the optical energy does not reach the detector or is spread between multiple detectors. This design strategy reduces the dynamic range requirements of the detector and prevents the detector from damage.

Acquisition of the lidar imagery can include, for example, a 3D lidar system embedded in the front of car, where the 3D lidar system, includes a laser transmitter with any necessary optics, a single-element photoreceiver with any necessary dedicated or shared optics, and an optical scanner used to scan (“paint”) the laser over the scene. Generating a full-frame 3D lidar range image—where the field of view is 20 degrees by 60 degrees and the angular resolution is 0.1 degrees (10 samples per degree)—requires emitting 120,000 pulses [(20*10*60*10)=120,000)]. When update rates of 30 frames per second are required, such as is required for automotive lidar, roughly 3.6 million pulses per second must be generated and their returns captured.

There are many ways to combine and configure the elements of the lidar system—including considerations for the laser pulse energy, beam divergence, detector array size and array format (single element, linear, 2D array), and scanner to obtain a 3D image. If higher power lasers are deployed, pixelated detector arrays can be used, in which case the divergence of the laser would be mapped to a wider field of view relative to that of the detector array, and the laser pulse energy would need to be increased to match the proportionally larger field of view. For example—compared to the 3D lidar above—to obtain same-resolution 3D lidar images 30 times per second, a 120,000-element detector array (e.g., 200×600 elements) could be used with a laser that has pulse energy that is 120,000 times greater. The advantage of this “flash lidar” system is that it does not require an optical scanner; the disadvantages are that the larger laser results in a larger, heavier system that consumes more power, and that it is possible that the required higher pulse energy of the laser will be capable of causing ocular damage. The maximum average laser power and maximum pulse energy are limited by the requirement for the system to be eyesafe.

As noted above, while many lidar system operate by recording only the laser time of flight and using that data to obtain the distance to the first target return (closest) target, some lidar systems are capable of capturing both the range and intensity of one or multiple target returns created from each laser pulse. For example, for a lidar system that is capable of recording multiple laser pulse returns, the system can detect and record the range and intensity of multiple returns from a single transmitted pulse. In such a multi-pulse lidar system, the range and intensity of a return pulse from a from a closer-by object can be recorded, as well as the range and intensity of later reflection(s) of that pulse—one(s) that moved past the closer-by object and later reflected off of more-distant object(s). Similarly, if glint from the sun reflecting from dust in the air or another laser pulse is detected and mistakenly recorded, a multi-pulse lidar system allows for the return from the actual targets in the field of view to still be obtained.

The amplitude of the pulse return is primarily dependent on the specular and diffuse reflectivity of the target, the size of the target, and the orientation of the target. Laser returns from close, highly-reflective objects are many orders of magnitude greater in intensity than the intensity of returns from distant targets. Many lidar systems require highly sensitive photodetectors, for example avalanche photodiodes (APDs), which along with their CMOS amplification circuits allow low reflectivity targets to be detected, provided the photoreceiver components are optimized for high conversion gain. Largely because of their high sensitivity, these detectors may be damaged by very intense laser pulse returns.

However, capturing the intensity of pulses over a larger dynamic range associated with laser ranging may be challenging because the signals are too large to capture directly. One can infer the intensity by using a recording of a bit-modulated output obtained using serial-bit encoding obtained from one or more voltage threshold levels. This technique is often referred to as time-over-threshold (TOT) recording or, when multiple-thresholds are used, multiple time-over-threshold (MTOT) recording.

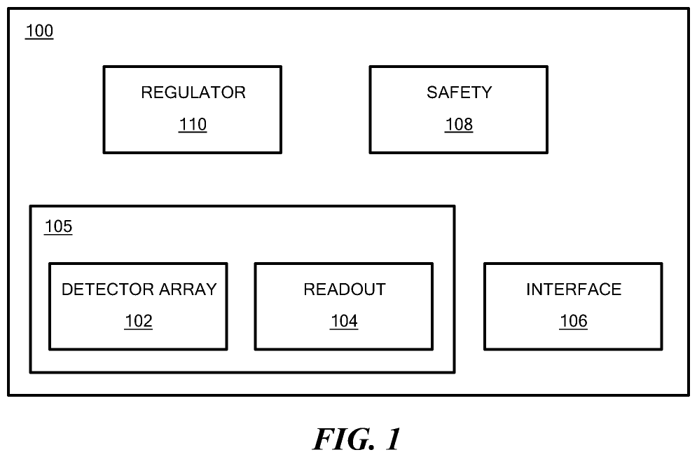

FIG. 1 shows an example optical detector system 100 having a fast recovery from high amplitude pulses, such as backscatter, during initial acquisition in accordance with example embodiments of the disclosure. The illustrated system 100 includes a photo-detector array 102 to convert incident photon energy striking the photo-detectors in the array into current flow that is proportional to the number of photons striking the photo-detectors. The photo-detector device can comprise a photo-diode which creates reverse-bias current flow proportional to photons of particular wavelengths striking the device and has intrinsic capacitance between the anode and cathode.

As used herein, a photodetector refers to an optical transducer with no signal processing, a photoreceiver refers to an optical transducer with signal processing, e.g., a ROIC, a ROIC refers to a Read-Out Integrated Circuit, and a sub-mount refers to a breakout circuit with no signal processing that is used for photodetectors in place of a ROIC. Back-scatter refers to an unwanted optical signal that scatters into the photoreceiver when an optical pulse is transmitted from a corresponding laser output or other optical transmitter. The term T0 refers to an initial time of a signal return acquisition window and also denotes the time when an outgoing optical signal is generated in a reflection-based optical system. A back-scatter event occurs close to this time.

The detector array 102, which can comprise a sensor chip assembly (SCA) 105 having an array of pixels, is coupled to a readout module 104, such as a readout integrated circuit (ROIC). Although the SCA 105 is shown as a ROIC and detector array in another embodiment they may comprise one piece of material, for example a monolithic silicon detector. In addition, the READOUT module 106 may comprise a silicon circuit and the detector module 102 may comprise a different material, such as, but not limited to GaAs, InGaAs, InGaAsP, and/or other detector materials.

In embodiments, the detector array 102 can comprise a single pixel, or an array of multiple pixels arranged in one dimension (1D), or two dimensions (2D). An interface module 106 can output the information from the readout module 104. A safety module 108 can analyze operation of the detector system 100 and may generate alerts upon detecting one or more faults. In embodiments, the safety module 108 can include active pixel test injection functionality. In embodiments, the safety module 108 can provide Automotive Safety Integrity Level (ASIL) related functionality, as described more fully below. The detector system 100 can include a regulator 110 to provide one or more regulated voltages for the system.

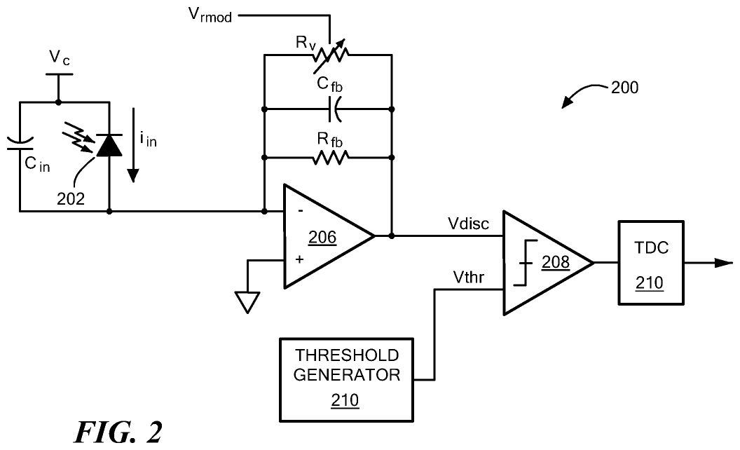

FIG. 2 shows an example implementation of a portion of a photoreceiver embodiment 200 having fast recovery from high amplitude pulses, such as optical backscatter, during initial acquisition in accordance with example embodiments of the disclosure. The optical detection system 200 is configured to recover from high-amplitude pulses during an initial period of the acquisition time window that may be caused, for example, by optical T0 back-scatter. In embodiments, the system 200 may recover from a high-amplitude pulse within 10 ns or within two meters of visible distance.

In some embodiments, the system 200 modulates the gain of a photoreceiver over the duration of a signal acquisition window, such that the system has a low gain at the beginning of the acquisition and a progressively higher gain over remaining window acquisition. Gain adjustment over the acquisition window may have a profile over time configured to meet the needs of a particular application. In some embodiments, an offset of the system can be corrected for high-gain configurations. In some embodiments, a system can adjust a dynamic range and/or damage threshold of a photoreceiver over the duration of the acquisition window.

A sensor 202, which is shown as a photo detector diode having an inherent capacitance Cin, is coupled to a resistive-transimpedance amplifier (RTIA) 206 for converting current generated by the photodiode 202 input into a voltage at its output. In other embodiments, a CTIA structure can be used. The optical detector 200 detects current inputs from the photodetector 202 and produces a digital output pulse consistent with the arrival time of the current input pulse and with a width proportional to the width and/or amplitude of the current pulse.

In some embodiments, a receiver generates an analog output where there is no on-chip discriminator or TDC since the output of the receiver is the analog output of the TIA.

In the illustrated embodiment, the transimpedance amplifier 206 converts the photo-current input pulse Iᵢₙ from the photodetector 202 into an output voltage pulse V_{disc}, which is input to a voltage discriminator 208. When the voltage pulse V_{disc} exceeds a threshold Vₜₕᵣ injected by a threshold generator 210, the discriminator 208 detects this and produces a digital pulse with a width proportional to the time the signal is greater than the threshold. The rising edge of the digital output approximates the arrival time of the active transient photocurrent pulse and the width of the digital output pulse is proportional to the amplitude of the active transient photo-current pulse. The rising and falling edges of the digital pulse from the voltage discriminator 208 can be timed with a time-to-digital converter (TDC) 210.

The detector 200 can include a feedback network having a feedback resistor R_{fb}, which sets the amplifier 206 gain, coupled across the output and the current Iᵢₙ input and a feedback capacitor C_{tb}, which tunes the frequency response of the circuit. In embodiments, the feedback network includes a variable resistor module Rᵥ also coupled in a feedback configuration that provides a selectable impedance for controlling the amplifier gain, and thus, recovery characteristics of the circuit. In embodiments, control signal V_{rmod} controls the resistance of R_{V}, such that R_{V,min}<<R_{fb} and R_{V,max}>>R_{fb}.

It is understood that the variable resistor module Rᵥ can be provided by any suitable component and/or circuit configuration to implement adjustable resistance. In some embodiments, a variable impedance module can replace or be used in addition to, the variable resistor module Rᵥ to provide further control over the amplifier operating characteristics.

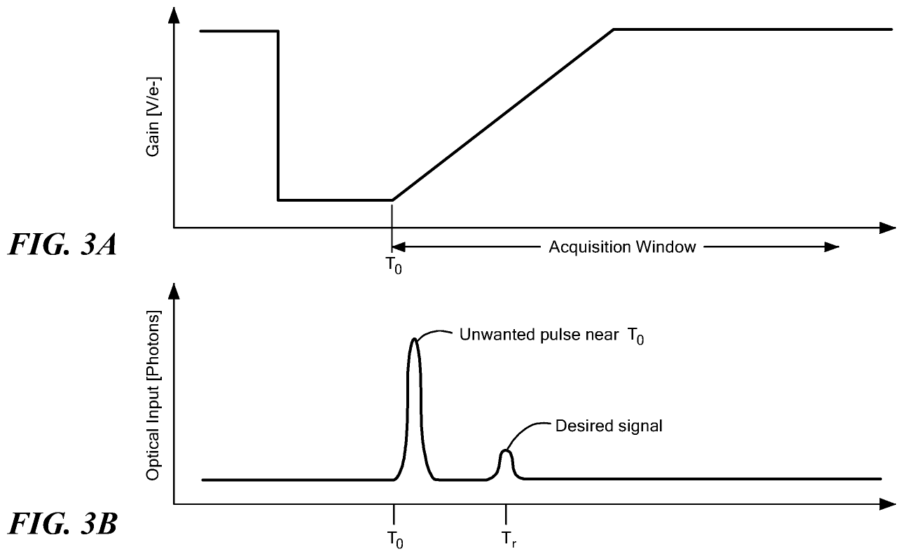

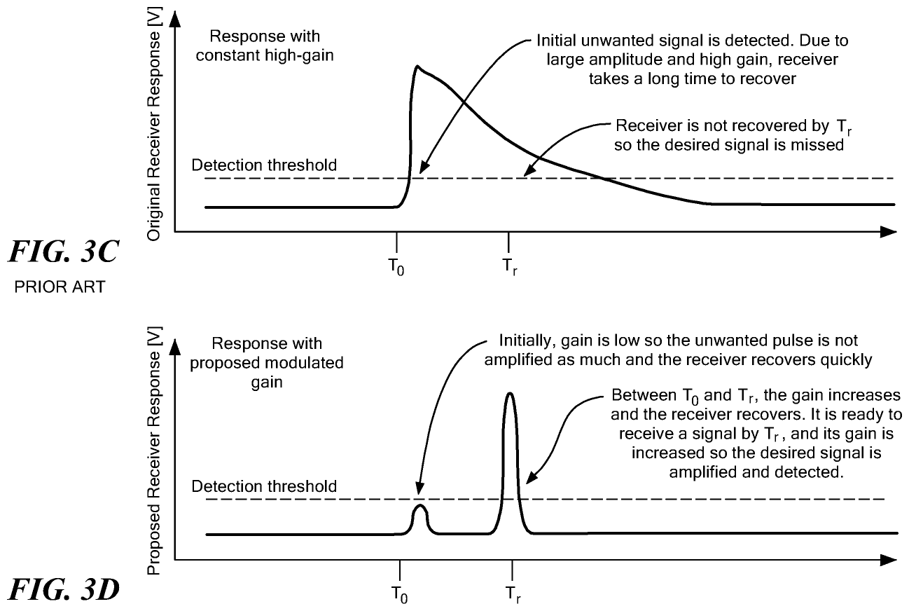

FIG. 3A shows an example gain profile for an example optical detection system over an acquisition window that begins at an initial time T0. In the illustrated embodiment, the gain is lowest at the initial time T0 and linearly increases to a maximum value that is maintained until the window ends. FIG. 3B shows an unwanted pulse near time T0, which may comprise a backscatter pulse, and a desired signal pulse at time Tᵣ. FIG. 3C shows a prior art optical detector with a constant gain that misses the desired signal pulse at time Tᵣ (see FIG. 3B) due to the backscatter signal at T0 (see FIG. 3B) and a long recovery time. FIG. 3D shows an example response for the optical detector 200 of FIG. 2. As can be seen, the low gain at the initial time T0 prevents the high amplitude backscatter pulse from reaching the detection threshold. Due to the low amplification of the backscatter pulse, the receiver recovers quickly from the high amplitude backscatter pulse and detects the desired signal pulse at time Tr. In an example embodiment, the gain profile of FIG. 3A results in the receiver response shown in FIG. 3D to the pulses shown in FIG. 3B.

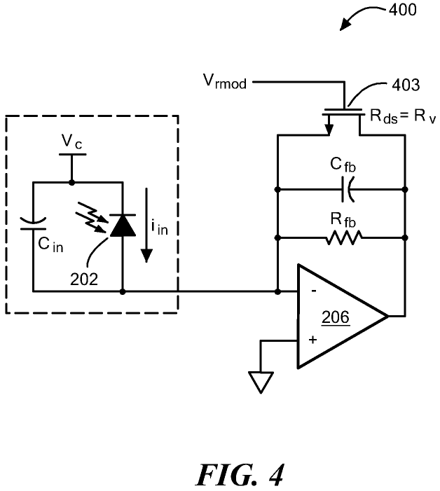

FIG. 4 shows an optical detector 400 having commonality with the detector 200 of FIG. 2 with a variable resistor module implemented by MOS device 403, which may be NMOS or PMOS, operating in the linear (triode) region that provides the MOS device a variable drain-source resistance R_{ds} that is modulated by a voltage V_{rmod}. As described above, controlling voltage V_{rmod} controls the gain of the input signal to the amplifier 206.

In embodiments, any practical gain profile can be achieved by controlling the V_{rmod} signal to adjust the timing to meet the needs of a particular application.

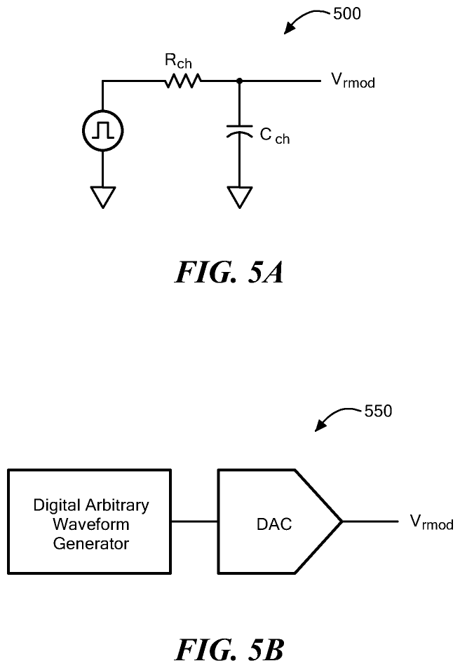

FIG. 5A shows an example circuit implementation 500 comprising an RC network having resistor R_{ch} and capacitor C_{ch} coupled to a pulse generator to generate voltage V_{rmod}. The RC network is driven by a square pulse to charge and discharge the RC network which allows tuning of the rate of change of V_{rmod} by changing the impedance of R_{ch} and/or C_{ch}, and/or other devices that can make up the RC charge network.

FIG. 5B shows an example circuit implementation 550 generating V_{rmod} using a digital arbitrary waveform generator to generate waveforms having any arbitrary shape and to convert the digital signal to analog by a DAC to control resistance R_{V} (see FIGS. 2 and 4). This configuration allows arbitrary shape and fine adjustment of the gain profile of the system over time.

It is understood that any practical circuit configuration can be used to provide a desired gain profile by controlling the impedance of the feedback network of the amplifier. For example, a constant current into a capacitor can create a linear ramp of voltage at a rate defined by I and C to provide V_{rmod}.

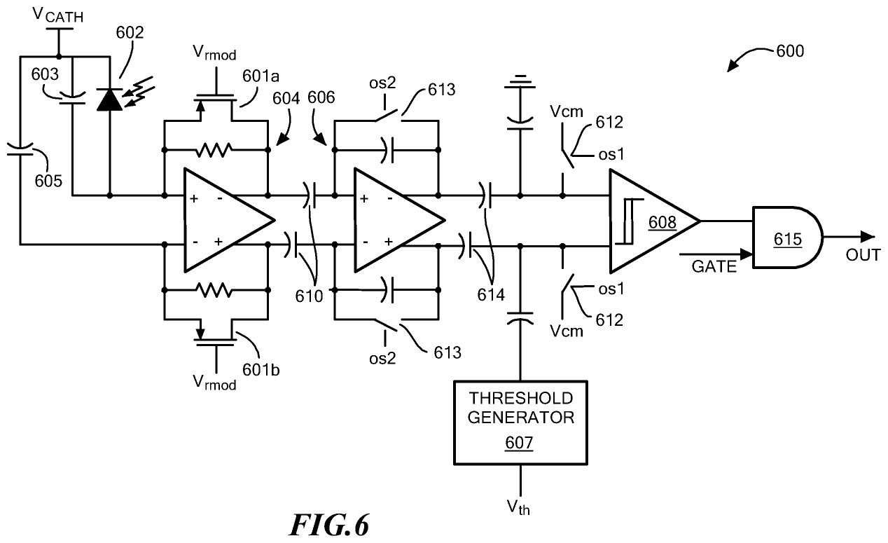

FIG. 6 shows an example implementation 600 having a differential amplification chain including a variable gain first stage transimpedance amplifier and a comparator to digitize the signal for mitigating the impact of charge injections from the modulating switch by making them common-mode instead of single ended. With a differential implementation such as this, gain can be modulated at a higher rate than the single-ended implementation without causing a false detection allowing full sensitivity of the receiver to be recovered in a shorter amount of time. Respective variable resistor modules 601a,b are coupled across the amplifier 604 to control the amplifier gain and receiver response, as described above.

The illustrated differential LiDAR receiver embodiment 600 of FIG. 6 includes a background and dark current removal system 600 with a desired gain profile modification devices 601a and 601b and includes a photo-detector diode 602 coupled to a differential resistive transimpedance amplifier 604. A differential voltage gain circuit 606 receives an input from the RTIA 604 and provides an output to a voltage discriminator 608. Background offset storage capacitors 610,614 can be coupled between the RTIA circuit 604, the voltage gain circuit 606 and the voltage discriminator 608. Timing control switches 612,613 can be provided for offset storage.

In embodiments, the photo-detector (PD) diode 602 generates current proportional to the incident photon flux striking the PD. The PD has an inherent capacitance 603 between the two terminals and may be matched with a capacitor 605 of the same value as the inherent capacitance of the PD to balance the differential circuit. The differential resistive transimpedance amplifier (RTIA) 604 generates a differential voltage proportional to the input current. This is true for static background and dark current as well as transient currents associated with active returns.

The voltage gain circuit (VG) 606 which follows the differential RTIA 604 amplifies this differential voltage signal and presents it to the capacitors 614 at the input of the voltage discriminator 608.

The background and offset storage capacitors pairs 610 and 614 may either be serially connected in an AC-coupled configuration to the voltage gain 606 and voltage discriminator 608 inputs respectively or directly coupled to ground from the inputs. The first set of offset storage capacitors 610 store the offset of the RTIA amplifier and the background optical signal. The second set of offset storage capacitors 614 store the offset of the voltage gain stage 606. Further utilizing input AC-coupling capacitor pairs 610 in the voltage gain stage 606 as offset and background storage improves the correction range by storing offsets before they are gained up by the VG stage 606.

The timing control switches toggle operations between storing background offsets and applying the offsets to the discriminator 608 inputs cancelling the offsets and allowing the circuit to only observe differences from that reference point. This is accomplished by driving the capacitor pairs 614 and/or 610 with the background level and connecting the opposite side of the capacitors to a reference voltage either generated by unity-gain amplifier configuration or direct connection to a reference voltage. Utilizing the unity-gain configuration for setting the reference voltage also stores the amplifier stage offset in the capacitor pair allowing cancellation of this error as well. The voltage difference is then sampled on the capacitors by opening switch pairs 612, 613 in sequence. This sampling occurs only moments before the circuit is to be used for active return acquisition thereby ensuring that background and dark current values are the same between the sampling moment and the acquisition moment. After sampling, the values stored on the capacitors 610,614 cancel amplifier offset and background signal offset such that there is zero offset at the input of the discriminator 608. Shortly after this offset and background sampling, a programmable threshold offset is injected to one or both sides of the discriminator 608 inputs setting a required threshold that an active return must exceed to trigger the discriminator output.

The offset storage operation may also include the offset sampling and storage of discriminator input-referred offsets. These offsets are stored on the capacitors connected to the discriminator inputs and instead of the discriminator input switches 612 sampling a reference voltage, the discriminator is configured during os1 to present the offset of the discriminator on the inputs. These inputs are then sampled and stored as a part of the offset storage operation and becomes the starting input voltages of the discriminator effectively removing contributions of the discriminator offset as well from the operation of the signal path.

In embodiments, the voltage level discriminator 608 compares two analog voltage inputs and produces a digital output whenever the positive input exceeds the voltage of the negative input. The output of the analog front end amplifying stage 606 is connected to the discriminator 608 either directly or through the AC-coupling capacitors 610. When the differential input exceeds an adjustable threshold provided by a threshold generator 607, the digital output transitions and indicates an event has occurred. The output of the voltage level discriminator 608 can be input to a logic gate 615, which is shown as an AND gate, with an input signal GATE, for example. Later time-to-digital conversion measures this moment in time compared to a reference and provides a digital code representing the time of this event.

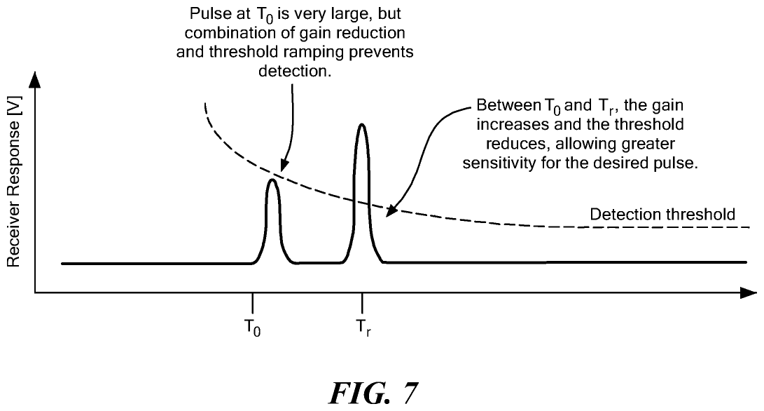

FIG. 7 shows an example embodiment having detection threshold modulation of the detection threshold (see, e.g., the threshold generation module 607 of FIG. 6) to provide immunity to large signal returns at or near time T0. As can be seen, the detection threshold falls off from a beginning of the acquisition window. A large pulse at T0 is prevented from detection by a combination of gain reduction and threshold ramping. Between time T0 and Tr, the gain increases and threshold reduces to allow greater sensitivity for desired pulses. In embodiments, a threshold is provided at a voltage discriminator (see 608 of FIG. 6) that is high at initial time T0 and reduces over time. This configuration can be configured to filter out relatively large T0 signals.

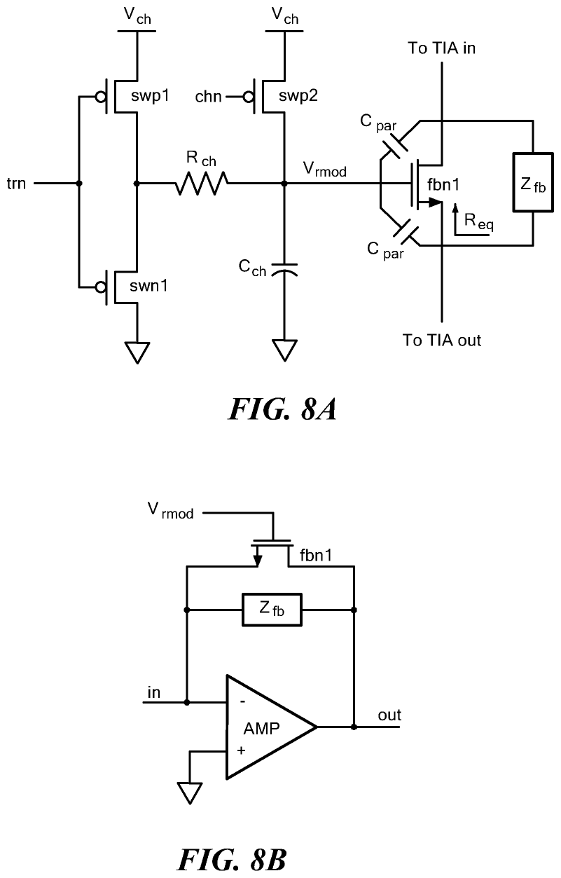

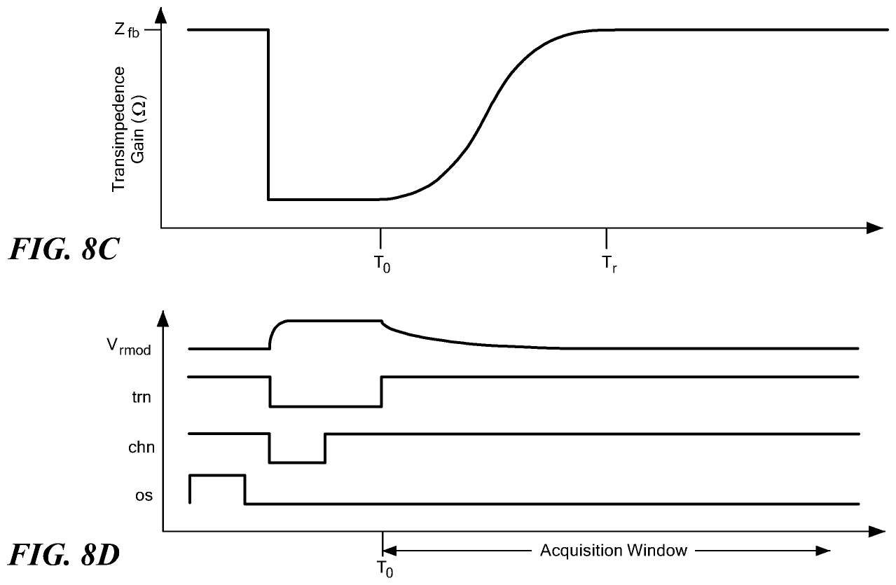

FIGS. 8A-8D show an example V_{rmod} modulation scheme to prevent charge injection and allow offset or background sampling. With this arrangement, there is reduced switching charge injection onto the input of the high-gain amplifier AMP through the parasitic capacitance Cₚₐᵣ. Cₚₐᵣ which can comprise device parasitic capacitances of a feedback component fbn1, in addition to any other stray coupling capacitance that may be present between the V_{rmod} node and the TIA in node. The charge injection is reduced by isolating the switching signal trn from the V_{rmod} node by a resistance R_{ch}. Charge may be injected by signal chn but this signal transitions before the Acquisition Window begins. The use of switch swp2 and signal chn allows for fast charging of the capacitor C_{ch} while still allowing the use of a larger R_{ch} to set the discharge time-constant of V_{rmod}. This allows reduced reset time of the system in between sequential acquisitions. In addition, background or offset measurements can be made in the time-period os before the gain is modulated. An example background or offset sampling and/or cancellation scheme is as described in Published PCT Application No. PCT/US2022/022294, which is incorporated herein by reference.

In operation, C_{ch} and R_{ch} are chosen to achieve a desired overall gain-transition characteristic. Node V_{rmod} begins (or is reset to) a low value which produces a high impedance R_{eq} on feedback device fbn1 which is substantially greater than Z_{fb}. The total feedback gain is defined by the parallel combination of the feedback network impedance Z_{fb} and the modulating device impedance. The maximum gain of the system occurs when R_{eq} is very large compared to Z_{fb} such that it can be defined as just Z_{fb}. When the system is in this state, offset or background signal may be sampled in an allowed time indicated by the os signal. At some time prior to T₀, signal trn and signal chn are switched to allow charging of capacitor C_{ch}. When C_{ch} is sufficiently charged the chn signal is switched so that swp2 is open. Some buffer of time should be given to allow any charge-injection from chn to settle. After this time, signal trn is switched at T₀. This allows the capacitor C_{ch} to discharge through Rch and swn1. As the voltage V_{rmod} on capacitor C_{ch} is reduced, the total transimpedance gain increases, approaching the maximum gain of Z_{fb} at time Tᵣ

In embodiments, modulation is implemented differentially for a differential signal path which further reduces the impact of any charge-injection from switching signals trn or chn. In some embodiments, resistance modulation is implemented for a P-type feedback switch and/or both N- and P-type switches can be used in parallel with two complementary V_{rmod} generators.

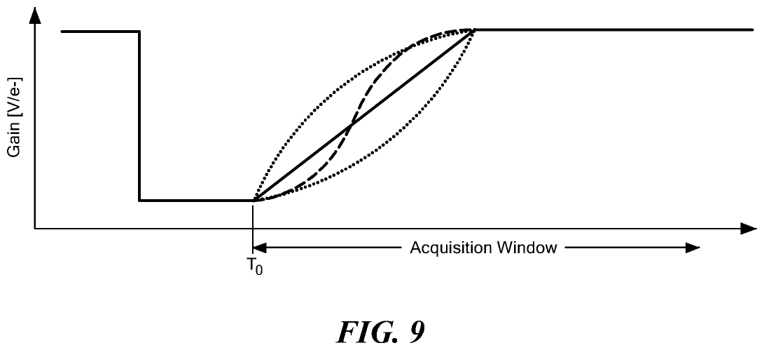

FIG. 9 shows an arbitrary gain characteristic that can be implemented by adjusting the characteristic of the V_{rmod} signal and the impedance response of the feedback device, such as fbn1, to that signal. The arbitrary gain characteristic can be implemented to tune the response of the system over time for a particular application.

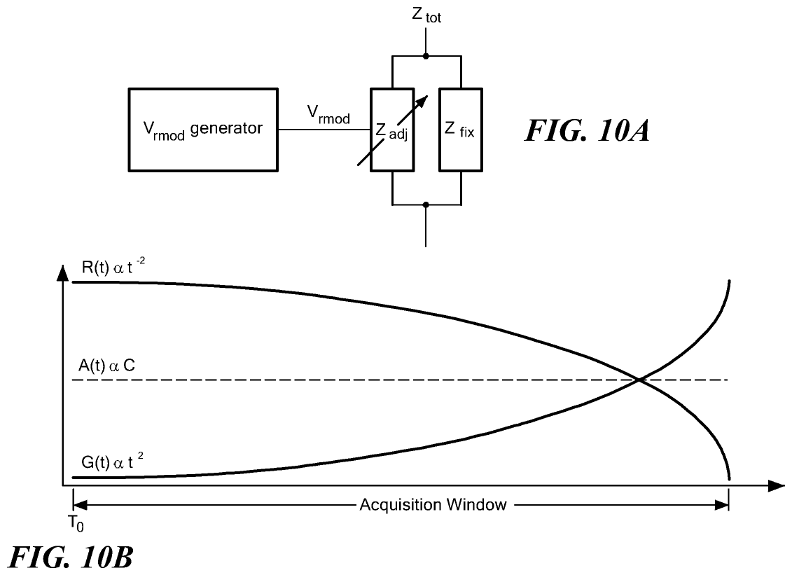

FIG. 10A and FIG. 10B show an example implementation to produce a gain characteristic proportional to the square of elapsed time. In the illustrated embodiment, an arbitrary gain characteristic is used to optimize the system response. An optical receiver measuring Time-of-Flight (TOF) by detecting the intensity of a received signal may implement a Gain-vs-time characteristic which matches the 1/d² dependence of the intensity of the received signal compared to the distance (d) of the receiver from the target. A functional representation of such a gain characteristic may be described by:

$$G ( t ) ∝ {t}^{2}$$

In this way, the variation in output amplitude of the system is reduced by matching the gain to the expected return amplitude at a given point in time in the measurement window. Output amplitude A(t) is proportional to the received signal intensity RSI times the system gain G. If RSI(t)∝1/t² then the output amplitude is proportional to a constant C.

$$A ( t ) ∝ RSI ( t ) * G ( t )$$

$$A ( t ) ∝ {t}^{2} * ( 1 / {t}^{2} ) = C$$

The above may be used to reduce the dynamic range requirements of the system.

FIG. 11 shows an example sequence of steps for controlling gain in a LIDAR photoreceiver to enable rapid recovery from unwanted high amplitude pulses at the beginning of an acquisition window. In step 1100, the LIDAR system is configured to transmit and receive pulses and detect targets in a field of view. In step 1102, a gain profile for the photoreceiver is configured to have a relatively low gain at the beginning of the acquisition window. In step 1104, a signal is received, such as a high amplitude backscatter signal at T0. The low gain may prevent the system from identifying the unwanted backscatter as desired signal return. In step 1106, the receiver quickly recovers from the backscatter pulse. With a low gain, the receiver can quickly recover from a high amplitude backscatter pulse at the beginning of the window. In step 1108, a desired pulse is received and detected as desired signal return, e.g., signal reflected from a target.

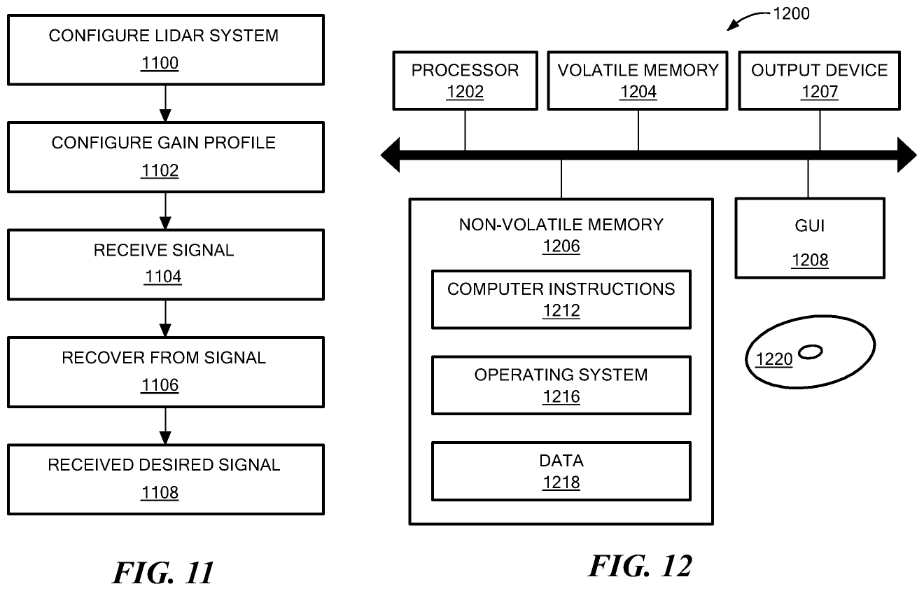

FIG. 12 shows an exemplary computer 1200 that can perform at least part of the processing described herein. For example, the computer 1200 can perform processing to generate a control signal for a variable resistance module for controlling signal gain. The computer 1200 includes a processor 1202, a volatile memory 1204, a non-volatile memory 1206 (e.g., hard disk), an output device 1207 and a graphical user interface (GUI) 1208 (e.g., a mouse, a keyboard, a display, for example). The non-volatile memory 1206 stores computer instructions 1212, an operating system 1216 and data 1218. In one example, the computer instructions 1212 are executed by the processor 1202 out of volatile memory 1204. In one embodiment, an article 1220 comprises non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., RAM/ROM, CD-ROM, hard disk, or magnetic diskette) that is readable by a general or special purpose programmable computer for configuring and operating the computer when the storage medium or device is read by the computer.

Processing may also be implemented as a machine-readable storage medium, configured with a computer program, where upon execution, instructions in the computer program cause the computer to operate.

Processing may be performed by one or more programmable processors executing one or more computer programs to perform the functions of the system. All or part of the system may be implemented as, special purpose logic circuitry (e.g., an FPGA (field programmable gate array), a general purpose graphical processing units (GPGPU), and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not specifically set forth above. Various elements, which are described in the context of a single embodiment, may also be provided separately or in any suitable subcombination. Other embodiments not specifically described herein are also within the scope of the following claims.

What is claimed is:

1. A method, comprising:
configuring a photoreceiver of a LIDAR system to receive a return signal; and
modulating a gain of the photoreceiver over an acquisition window for the return signal, wherein the acquisition window contains time T0, and wherein the gain at time T0 is at a minimum for the acquisition window.

2. The method according to claim 1, wherein the time T0 is at the beginning of the acquisition window.

3. The method according to claim 1, wherein modulating the gain of the photoreceiver includes selecting the gain to keep a backscatter pulse for the return signal below a detection threshold.

4. The method according to claim 1, wherein a profile of the gain is linear.

5. The method according to claim 1, wherein the photoreceiver includes a photodiode coupled to an amplifier having a feedback circuit which includes a variable impedance module that controls the gain.

6. The method according to claim 5, further including adjusting a control signal to the variable impedance module for controlling an impedance of the variable impedance module and adjusting the gain.

7. The method according to claim 6, wherein the variable impedance module comprises a first MOS device.

8. The method according to claim 7, further including operating the first MOS device in a linear region.

9. The method according to claim 8, further including using an RC network to generate the control signal to the variable impedance module.

10. The method according to claim 9, further including generating the control signal to the variable impedance module to reduce switching charge injection.

11. The method according to claim 8, further including using a digital arbitrary waveform generator to generate the control signal to the variable impedance module.

12. The method according to claim 11, further including a lookup table to control the digital arbitrary waveform generator.

13. The method according to claim 1, wherein the photoreceiver includes a differential circuit to process the return signal.

14. The method according to claim 1, wherein the photoreceiver includes an amplifier and a voltage discriminator and a threshold generator to generate a threshold for the voltage discriminator, and controlling the threshold for the voltage discriminator to be greater than a minimum at the beginning of the acquisition window.

15. The method according to 1, wherein a profile of the gain is nonlinear.

16. The method according to claim 1, where a profile of the gain is proportional to a square of elapsed time for distance from a target that generates the signal return.

17. The method according to claim 8, wherein a first timing signal trn and a second timing signal chn are staggered in time and coupled to further MOS devices swp1, swn1, and swp2 to actuate a gate voltage V_{rmod} to reset the V_{rmod} voltage between signal acquisitions and to enable V_{rmod} modulation to be triggered with a charge injection over a threshold level through parasitic capacitances.

18. A LIDAR system, comprising:
a photoreceiver to receive a return signal; and
a circuit to modulate a gain of the photoreceiver over an acquisition window for the return signal, wherein the acquisition window contains time T0, and wherein the gain at time T0 is at a minimum for the acquisition window.

19. The system according to claim 18, wherein the time T0 is at the beginning of the acquisition window.

20. The system according to claim 18, wherein modulating the gain of the photoreceiver includes selecting the gain to keep a backscatter pulse for the return signal below a detection threshold.

21. The system according to claim 18, wherein a profile of the gain is linear.

22. The system according to claim 18, wherein the photoreceiver includes a photodiode coupled to an amplifier having a feedback circuit which includes a variable impedance module that controls the gain.

23. The system according to claim 22, wherein the system is configured to adjust a control signal to the variable impedance module for controlling an impedance of the variable impedance module and adjusting the gain.

24. The system according to claim 23, wherein the variable impedance module comprises a first MOS device.

25. The system according to claim 24, wherein the system is configured to operate the first MOS device in a linear region.

26. The system according to claim 25, further including an RC network to generate the control signal to the variable impedance module.

27. The system according to claim 26, wherein the system is configured to generate the control signal to the variable impedance module to reduce switching charge injection.

28. The system according to claim 25, further including a digital arbitrary waveform generator to generate the control signal to the variable impedance module.

29. The system according to claim 28, further including a lookup table to control the digital arbitrary waveform generator.

30. The system according to claim 18, wherein the photoreceiver includes a differential circuit to process the return signal.

31. The system according to claim 18, wherein the photoreceiver includes an amplifier and a voltage discriminator and a threshold generator to generate a threshold for the voltage discriminator, and controlling the threshold for the voltage discriminator to be greater than a minimum at the beginning of the acquisition window.

32. The system according to claim 18, wherein a profile of the gain is nonlinear.

33. The system according to claim 18, where a profile of the gain is proportional to a square of elapsed time for distance from a target that generates the signal return.

34. The system according to claim 24, wherein a first timing signal trn and a second timing signal chn are staggered in time and coupled to further MOS devices swp1, swn1, and swp2 to actuate a gate voltage V_{rmod} to reset the V_{rmod} voltage between signal acquisitions and to enable V_{rmod} modulation to be triggered with a charge injection over a threshold level through parasitic capacitances.
